(19) United States
(12) Patent Application Publication
(10) Pub. No.: US 2025/0000080 A1
(43) Pub. Date: Jan. 2, 2025

(54) Microcontroller Button for Rat Trap with Internet Connectivity

(71) Applicant: Craig David Butler, Fullerton, CA (US)

(72) Inventor: Craig David Butler, Fullerton, CA (US)

(21) Appl. No.: 18/342,301

(22) Filed: Jun. 27, 2023

(51) Int. Cl. A01M 23/24; H04M 1/72412

(52) U.S. Cl. CPC A01M 23/245; H04M 1/72412

(57) ABSTRACT

A microcontroller button for use with rat traps is provided that can connect to the internet and send messages to a predetermined IP address. The button is positioned underneath the trigger of nearly any rat trap and sends a “Set” message when not pushed and a “Capture” message when pushed. Upon activation, the button prompts a user to input WiFi credentials to establish an internet connection. The button's software can be accessed via a downloadable phone app, which displays trap status.

### PRIOR ART

Rat traps have long been employed as effective means to control and capture rodents. Traditional rat traps rely on mechanical mechanisms, such as spring-loaded traps or snap traps, triggered by the rodent's movement or touch. While effective, these conventional traps lack advanced features for remote monitoring and status updates, necessitating physical inspection and potential delays in capturing and removing trapped rodents. Recent advancements in internet connectivity and smart devices have opened doors for innovative solutions to enhance the effectiveness and convenience of rat traps. Remote monitoring and control of trap status, real-time notifications, and data logging have become desirable features for pest control management.

### BACKGROUND OF THE INVENTION

The present invention relates to rat traps and, more specifically, to a microcontroller button that can be placed underneath the trigger mechanism of a rat traps and enables internet connectivity for remote monitoring and control.

### SUMMARY OF THE INVENTION

The Microcontroller Button for Rat Traps with Internet Connectivity provides a novel solution to overcome the limitations of conventional rat traps by integrating a microcontroller button that can be placed under the trigger mechanism of a rat trap. This inventive device enables internet connectivity, facilitating remote monitoring and control of the trap's status through a smart phone application.

### BRIEF DESCRIPTION OF DRAWINGS

FIG. 1: The microcontroller button is shown as a compact and discrete device designed to be placed underneath the trigger mechanism of a rat trap. The button is enclosed within a specially designed housing, which is visible in the picture. The housing is compact and appropriately sized to fit securely under the trap's trigger mechanism without interfering with its operation. The button's housing incorporates a sleek and ergonomic design, ensuring a seamless integration with the rat trap. The material used for the housing is durable and resistant to environmental conditions, ensuring the longevity and reliability of the device. Located on the top surface of the button, there is a prominently positioned circular button. The button is designed to align precisely with the rat trap's trigger mechanism, allowing for seamless interaction and operation. It is sensitive to touch or motion, responding to the activation of the trap. The wireless module, which enables the button's internet connectivity, is not visible in the picture as it is housed within the button's enclosure. However, its presence and integration can be inferred from the button's functionality and the accompanying description. The picture captures the essential elements of the Microcontroller Button for Rat Traps with Internet Connectivity, showcasing its compact size, discrete appearance, and intuitive design. It serves to provide a visual representation of the button, emphasizing its role in enhancing the functionality and convenience of rat traps through wireless communication.

FIG. 2: The button itself is positioned strategically to be triggered by the rat trap's trigger mechanism. It is designed to align with and respond to the motion or touch that activates the trap. When the trap is set and the button is in its default state, it remains unpressed, ready to send a “Set” message upon request. However, when the trap is triggered, the button is pressed, indicating a capture, and promptly sends a “Capture” message to the connected smartphone application.

FIG. 3: Within the housing, the microcontroller is discreetly housed, providing the necessary processing power and control functionalities for the button's operation. The wireless module, responsible for enabling wireless communication capabilities, is shown as an integrated component connected to the microcontroller. This module facilitates communication between the microcontroller button and external devices such as a smartphone.

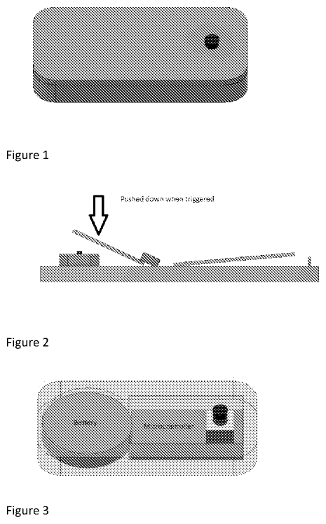

### DETAILED DESCRIPTION OF THE INVENTION

The Microcontroller Button for Rat Traps with Internet Connectivity combines the traditional functionality of a rat trap with modern technology, resulting in an advanced device that significantly enhances the effectiveness and convenience of rodent control. In operation, the microcontroller button is positioned underneath the trigger mechanism of a rat trap. The specially designed housing ensures a secure fit, maintaining the trap's functionality while accommodating the additional electronic components. The microcontroller, discreetly housed within the button, serves as the central processing unit, responsible for various control functions and communication with external devices. A wireless module is operatively connected to the microcontroller, enabling wireless communication capabilities. This wireless connectivity allows the button to establish a direct connection with a smartphone application, eliminating the need for a dedicated server infrastructure. The wireless module supports standard communication protocols, such as Wi-Fi or Bluetooth, enabling seamless integration with existing smart devices. The button is strategically positioned to be triggered by the rat trap's trigger mechanism. When the trap is set, the button remains in its default state, ready to send a “Set” message upon request. As soon as the trap is triggered, the button is pressed, indicating a capture, and promptly sends a “Capture” message to the connected smartphone application. To initiate the internet connectivity, the user turns on the microcontroller button, prompting the user to input the Wi-Fi credentials of the desired router. Once the button successfully establishes an internet connection, it runs its software, allowing it to communicate with the smartphone application. The smartphone application, which can be downloaded by the user, provides an intuitive user interface that displays the trap's status in real-time. Users can conveniently monitor multiple traps, receive instant notifications upon capture, and remotely control trap functions through the application. This remote accessibility eliminates the need for physical inspections, enhances trap management efficiency, and enables prompt removal of captured rodents. The Microcontroller Button for Rat Traps with Internet Connectivity represents a significant advancement in the field of pest control management. By integrating modern technology into traditional rat traps, this inventive device provides improved monitoring capabilities, streamlined data collection, and remote control functionality, revolutionizing the way rodent control is performed. It is to be understood that the foregoing description is illustrative and not restrictive, and that the embodiments of the present invention may be modified or varied without departing from the scope or spirit of the invention. The invention is intended to encompass all such modifications and variations within its scope.

1. A housing designed to fit underneath the trigger mechanism of a rat trap.

2. A microcontroller housed within the housing.

3. A wireless module connected to the microcontroller.

4. A button positioned to be triggered by the rat trap's trigger mechanism.

5. Software executed by the microcontroller, enabling communication with a smartphone app without the need for a dedicated server.
